(19) United States
(12) Patent Application Publication
(10) Pub. No.: US 2016/0309541 A1
(43) Pub. Date: Oct. 20, 2016

(54) WIRELESS COMMUNICATION SYSTEM, WIRELESS COMMUNICATION APPARATUS, AND WIRELESS COMMUNICATION METHOD

(71) Applicant: FUJITSU LIMITED, Kawasaki-shi (JP)

(72) Inventors: YUN WEN, Kawasaki (JP); Hiroshi Fujita, Yokosuka (JP)

(73) Assignee: FUJITSU LIMITED, Kawasaki-shi (JP)

(21) Appl. No.: 15/077,860

(22) Filed: Mar. 22, 2016

(30) Foreign Application Priority Data
Apr. 14, 2015 (JP) 2015-082686

(51) Int. Cl. H04W 76/04; H04W 56/00; H04L 12/26

(52) U.S. Cl. CPC H04W 76/046; H04L 43/0847; H04W 56/0015

(57) ABSTRACT

A wireless communication apparatus capable of wirelessly communicating with a first terminal and a second terminal, includes: a processor configured to execute a process including: detecting non-delivery of data from the first terminal; and causing, when the non-delivery of the data is detected, the second terminal to transition into a communicable state for a predetermined time period that is within a cycle of data transmissions to the wireless communication apparatus and is common between the first terminal and the second terminal, by transmitting information causing the second terminal to transition into the communicable state to the second terminal.

### CROSS-REFERENCE TO RELATED APPLICATION

This application is based upon and claims the benefit of priority of the prior Japanese Patent Application No. 2015-082686, filed on Apr. 14, 2015, the entire contents of which are incorporated herein by reference.

### FIELD

The embodiments discussed herein are related to a wireless communication system, a wireless communication apparatus, and a wireless communication method.

### BACKGROUND

Conventionally, in the fields of agriculture, infrastructure, and the like, a wireless communication network has been used in which a collecting terminal (e.g., a gateway) that establishes a connection to a backbone network collects sensing data from a plurality of wireless terminals by performing direct communication therewith. In such a wireless communication network, the wireless terminals periodically transmit packets each containing the sensing data to the collecting terminal. When detecting consecutive occurrences of non-delivery of packets from a certain wireless terminal, the collecting terminal determines that a failure has occurred with the wireless terminal. In that situation, it is effective for the wireless communication network to identify the cause of the failure, in order to recover from the failure that occurred.

As a method for identifying the cause of a failure, for example, Japanese Laid-open Patent Publication No. 54-110702 proposes a method by which a failure detecting terminal transmits data to a failed terminal via a relay terminal so as to receive a response from the failed terminal. According to this method, when the failure detecting terminal corresponding to a collecting terminal is able to receive a response signal from the failed terminal, it is determined that the occurrence of the failure is caused by a wireless link failure between the failed terminal and the failure detecting terminal. On the contrary, when the failure detecting terminal is unable to receive a response signal from the failed terminal, it is determined that the occurrence of the failure is caused by a defect of the failed terminal itself.

Further, as an example of the wireless communication network described above, in a sensor network in which sensing data is regularly collected by using a singles hop, each of the wireless terminals transitions from a sleep mode into an active mode when transmitting data thereof and transitions back into the sleep mode after having completed the transmission. Further, the cycles of the active modes are not necessarily in synchronization among the wireless terminals. For this reason, it would be difficult to transmit data to a wireless terminal experiencing a failure via a wireless terminal experiencing no failure. To cope with this problem, for example, Japanese Laid-open Patent Publication No. 2011-223419 proposes a method by which a collecting terminal transmits a synchronization signal to all the wireless terminals in a network, so that the wireless terminals periodically transition back and forth between an active mode and a sleep mode at mutually the same times.

By periodically setting a common active period with the wireless terminals as described above, it becomes possible to perform an inter-terminal communication for failure detection purposes. However, according to this method, the common active period for the failure detection purposes is always set, although periodically, regardless of whether or not a failure has occurred with another terminal. Consequently, the wireless terminals have an increased level of electric power consumption. In particular, when the transmissions and receptions of the synchronization signal sent from the collecting terminal, signal conflicts caused by direct communications among the terminals, and time lags involved in re-transmitting processes are taken into consideration, the common active period can be long. For example, when the quantity of wireless terminals is 100, the common active period can be a time period of 130 ms or longer.

### SUMMARY

According to an aspect of the embodiments, a wireless communication system includes a wireless communication apparatus and first and second terminals capable of wirelessly communicating with the wireless communication apparatus. The wireless communication apparatus includes: a processor configured to execute a process including: detecting non-delivery of data from the first terminal; and first transmitting, when the non-delivery of the data is detected, information causing the second terminal to transition into a communicable state to the second terminal. The first terminal includes: a first processor configured to execute a first process including causing, when a response signal issued in response to a data transmission fails to be received, the first terminal to transition into a communicable state for a predetermined time period that is within a cycle of the data transmission. The second terminal includes: a second processor configured to execute a second process including causing, upon receiving the information, the second terminal to transition into the communicable state for the predetermined time period that is common between the first terminal and the second terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a wireless communication system according to an embodiment;

FIG. 2 is a chart for explaining a problem of a related technique;

FIG. 3 is a drawing for explaining a failure detecting method according to an embodiment;

FIG. 4 is a block diagram illustrating a functional configuration of a collecting terminal;

FIG. 5 is a block diagram illustrating a functional configuration of a wireless terminal;

FIG. 6 is a block diagram illustrating a hardware configuration of the collecting terminal;

FIG. 7 is a flowchart for explaining a failure detection notifying process performed by the collecting terminal according to the embodiment;

FIG. 8 is a flowchart for explaining a failure detection period setting process performed by the wireless terminal;

FIG. 9 is a drawing for explaining a failure detecting method according to a first modification example;

FIG. 10 is a drawing for explaining a failure detecting method according to a second modification example;

FIG. 11 is a flowchart for explaining a failure detection notifying process performed by the collecting terminal according to the second modification example;

FIG. 12 is a drawing for explaining a problem in a failure notification using MAC_ACK signals when data is transmitted using different cycles;

FIG. 13 is a drawing for explaining a failure detecting method according to a third modification example;

FIG. 14 is a drawing for explaining a failure detecting method according to a fourth modification example;

FIG. 15A is a diagram illustrating a wireless communication system in which six wireless terminals are present as being subordinate to the collecting terminal according to the fourth modification example;

FIG. 15B is a table illustrating transmission cycles for sensing data and dummy data from each of the wireless terminals according to the fourth modification example;

FIG. 15C is a chart for explaining a method for assigning dummy data transmission cycles according to the fourth modification example;

FIG. 16 is a flowchart for explaining a dummy data transmission cycle assigning process performed by the collecting terminal according to the fourth modification example; and

FIG. 17 is a drawing for explaining advantageous effects of wireless communication systems.

### DESCRIPTION OF EMBODIMENTS

Preferred embodiments will be explained with reference to accompanying drawings. The wireless communication system, the wireless communication apparatus, and the wireless communication method disclosed herein are not limited to the exemplary embodiments.

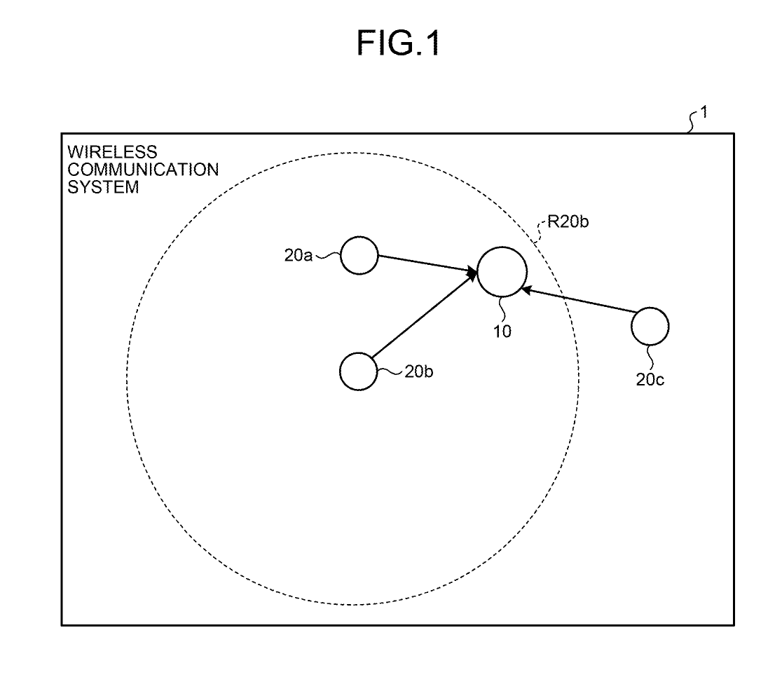

FIG. 1 is a diagram illustrating a configuration of a wireless communication system 1 according to an embodiment. As illustrated in FIG. 1, the wireless communication system 1 includes a collecting terminal 10 and a plurality of wireless terminals 20a to 20c. The wireless communication system 1 structures a sensor network in which the collecting terminal 10 regularly collects sensing data from the plurality of wireless terminals 20a to 20c. For example, when a failure has occurred in the data transmission performed by one or more of the wireless terminals 20, e.g., when the collecting terminal 10 consecutively fails to receive data, the wireless communication system 1 analyzes the cause of the failure in order to recover effectively. More specifically, the wireless communication system 1 judges whether the cause of the failure lies in a defect of the wireless terminal 20 itself experiencing the failure or lies in a failure (e.g., blockage, interference, noise, or the like) in a wireless link provided between the wireless terminal 20 and the collecting terminal 10. In the following sections, an example will be explained in which a failure has occurred with the wireless terminal 20b illustrated in FIG. 1. Further, in the following sections, the wireless terminal 20b experiencing the failure may be referred to as a failed terminal.

As a method for judging the cause of the failure, for example, the collecting terminal 10 transmits, as a broadcast transmission, a response request signal to the plurality of wireless terminals 20a to 20c. When the normal wireless terminals 20a and 20c experiencing no failures receive the response request signal from the collecting terminal 10, the wireless terminals 20a and 20c each rebroadcast the received response request signal. As for the wireless terminal 20b experiencing the failure, when the wireless terminal 20b itself has no defect, the wireless terminal 20b receives the response request signal from another wireless terminal (i.e., the wireless terminal 20a) that is present in a communication range R20b thereof. After that, the wireless terminal 20b sends, as a reply, a response reply signal to the collecting terminal 10 via the wireless terminal 20a. When having received the response reply signal from the wireless terminal 20b experiencing the failure within a predetermined time period since the rebroadcast, the collecting terminal 10 is able to determine that the cause of the failure lies in a failure in the wireless link provided between the wireless terminal 20b and the collecting terminal 10. In contrast, when the cause of the failure lies in a defect of the wireless terminal 20b itself, the collecting terminal 10 is able to determine that the cause of the failure lies in the defect of the wireless terminal 20b itself after the predetermined time period has elapsed, because no response reply signal is received from the wireless terminal 20b even via the wireless terminal 20a.

In this situation, to enable the wireless terminals 20a to 20c in the sensor network to perform the sensing process for a long period of time in the installed positions, it is effective to design a configuration capable of saving electric power. More specifically, to save electric power, each of the wireless terminals 20a to 20c performs an intermittent operation in which the wireless terminal transitions from a sleep mode (a power-saving mode) in which transmissions/receptions are not allowed, into an active mode in which transmissions/receptions are allowed when the wireless terminal is to transmit data therefrom and transitions back into the sleep mode when a transmission/reception of data is completed. In this situation, however, the judgment on the cause of the failure is realized, as described above, by the communication between the wireless terminal 20b experiencing the failure and the wireless terminal 20a experiencing no failure. For this reason, to judge the cause of the failure, a common active period is set during which both of the terminals are in the active mode at the same time.

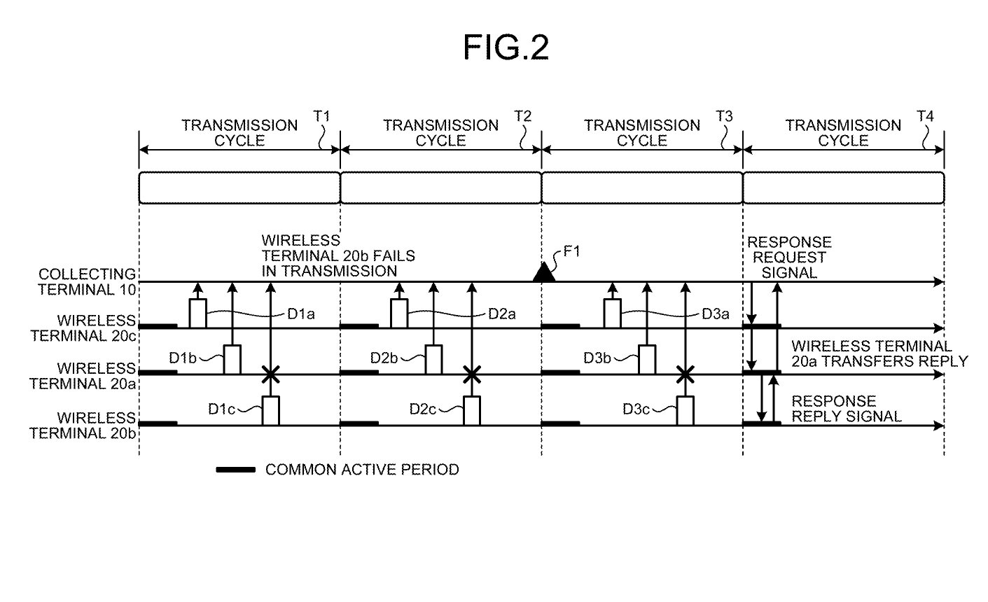

FIG. 2 is a chart for explaining a problem of the related technique. As illustrated in FIG. 2, the collecting terminal 10 causes the wireless terminals 20a to 20c to perform an intermittent operation periodically, by designating active periods for failure detection purposes (hereinafter, “failure-detection active periods”) that are common to the wireless terminals 20a to 20c, besides active periods used by the wireless terminals 20a to 20c to periodically transmit data packets. For example, in each of the transmission cycles of the data packets, a failure-detection active period is set in a head section of the cycle. As an alternative to the head sections of the transmission cycles of the data packets, the failure-detection active periods may be set with any other timing (e.g., in a tail section), as long as it is possible to avoid conflicts with the active periods used by the wireless terminals 20a to 20c to periodically transmit the data packets.

As indicated in FIG. 2, for example, when the wireless terminal 20b consecutively fails in data transmissions in two consecutive cycles (the transmission cycles T1 and T2 illustrated in FIG. 2), the collecting terminal 10 detects that a failure has occurred with the wireless terminal 20b. In the example illustrated in FIG. 2, the collecting terminal 10 detects that the wireless terminal 20b has consecutively failed in the data transmission, at a time F1 at which the transmission cycle T2 ends. Further, the collecting terminal 10 transmits a response request signal to the wireless terminals 20a to 20c during the common active period within the transmission cycle T4 following the detection of the occurrence of the failure. When the normal wireless terminals 20a and 20c experiencing no failures receive the response request signal, the wireless terminals 20a and 20c transfer the response request signal to the wireless terminal 20b by performing a broadcast transmission or a unicast transmission.

When having received the response request signal, the wireless terminal 20b sends, as a reply, a response reply signal to the collecting terminal 10 via a wireless terminal (the wireless terminal 20a in the example in FIG. 1) neighboring the wireless terminal 20b, among the other wireless terminals to which the signal was transmitted. When the collecting terminal 10 receives the response reply signal from the wireless terminal 20b before the predetermined time period elapses since the transmission of the response request signal, the collecting terminal 10 determines that the occurring failure is a wireless link failure. In contrast, when the collecting terminal 10 receives no response reply signal from the wireless terminal 20b before the predetermined time period elapses since the transmission of the response request signal, the collecting terminal 10 determines that the occurring failure is caused by a defect of the wireless terminal 20b itself. However, according to this failure detecting method, the common active period is set in each of all the transmission cycles, regardless of whether a failure has occurred or not. For this reason, even when no failure has occurred with the wireless terminals 20a to 20c, the wireless terminals 20a to 20c always transition into the active mode periodically. As a result, the wireless terminals 20a to 20c have an increased level of electric power consumption.

To cope with this situation, the wireless communication system 1 according to the embodiment does not set periodical common active periods with the wireless terminals 20a to 20c. Further, when the collecting terminal 10 detects a failure in the data transmission of the wireless terminal 20b, the collecting terminal 10 provides the wireless terminals 20a and 20b experiencing no failures with information indicating that the failure has occurred. The notifying information includes information designating a failure-detection common active period. The wireless terminals 20a and 20b experiencing no failures transition into the active mode during the common active period notified of by the collecting terminal 10. In contrast, the wireless terminal 20b experiencing the failure detects the data transmission failure thereof based on consecutive occurrences of not receiving ACK signals in response to data transmissions, or the like, and transitions into the active mode in the common active period designated in advance. Further, during the common active period, the cause of the failure is judged by performing the inter-terminal communication described above.

In this situation, the collecting terminal 10 may, for example, provide the wireless terminals 20a and 20b with the information about the occurrence of the failure and the common active period, by adding the information to a response signal issued in response to transmission data sent from the wireless terminals 20a and 20c experiencing no failures. The response signal may be, for example, an ACK signal in a Media Access Control (MAC) layer.

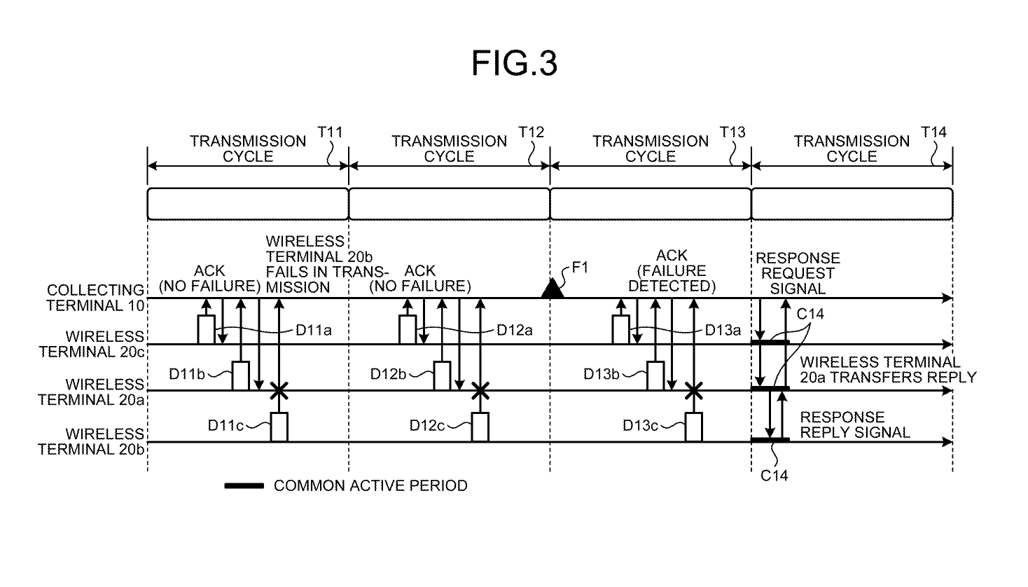

In the present embodiment, the collecting terminal 10 provides the notification about the occurrence of the failure by using an ACK signal in a MAC layer (hereinafter, “MAC_ACK signal”). FIG. 3 is a drawing for explaining a failure detecting method according to an embodiment. As illustrated in FIG. 3, while detecting no failure with the wireless terminal 20b, the collecting terminal 10 sends, as a reply, a MAC_ACK signal in response to the data transmitted thereto from each of the wireless terminals 20a and 20c, by arranging the MAC_ACK signal to contain information indicating that no failure has occurred. Further, when the wireless terminal 20b has consecutively failed in data transmission, the collecting terminal 10 detects a failure with the wireless terminal 20b. After that, the collecting terminal 10 sends, as a reply, a MAC_ACK signal in response to the data transmitted thereto from each of the wireless terminals 20a and 20c, by arranging the MAC_ACK signal to contain information indicating that the failure has occurred and information indicating the timing of a common active period C14.

When the wireless terminal 20b experiencing the failure has consecutively failed to receive the MAC_ACK signals, the wireless terminal 20b detects that the failure has occurred therewith and transitions into the active mode. In this situation, the time period during which the wireless terminal 20b transitions into the active mode may be arranged in advance so as to at least partially overlap with the common active period C14 of the wireless terminals 20a and 20c experiencing no failures. Alternatively, the time period during which the wireless terminal 20b transitions into the active mode may be the whole period of the transmission cycle T14 following the transmission cycle T13 in which the wireless terminal 20b detected the occurrence of the failure. When having received the MAC_ACK signal containing the information about the occurrence of the failure, the wireless terminals 20a and 20c experiencing no failures transition into the active mode according to the timing of the common active period C14 designated by the information contained in the MAC_ACK signal. With these arrangements, it is possible to judge the cause of the failure by performing the inter-terminal communication.

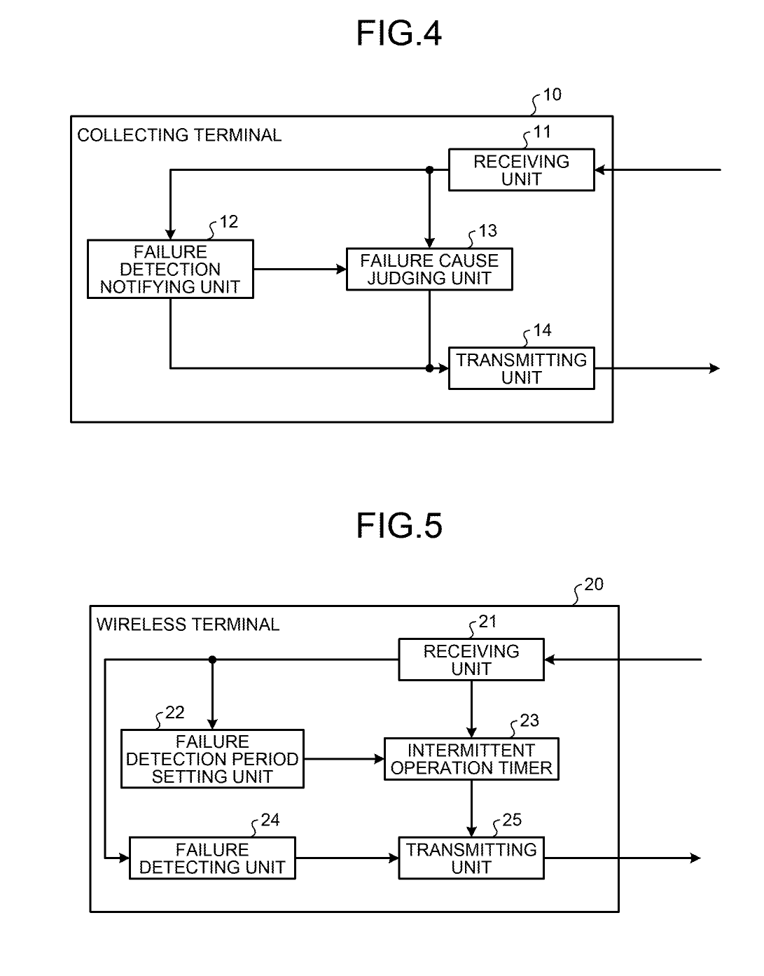

FIG. 4 is a block diagram illustrating a functional configuration of the collecting terminal 10. As illustrated in FIG. 4, the collecting terminal 10 includes a receiving unit 11, a failure detection notifying unit 12, a failure cause judging unit 13, and a transmitting unit 14. These constituent elements are connected together so as to be able to input and output signals and data in either one direction or two directions.

The receiving unit 11 receives a data signal and a response reply signal from any of the wireless terminals 20a to 20c that are subordinate thereto. The failure detection notifying unit 12 detects the occurrence of the failure with the wireless terminal 20b that was judged to have consecutively failed to receive the data, as being triggered by the consecutive occurrences of not receiving the data, and notifies the wireless terminals 20a and 20c experiencing no failures of the occurrence of the failure and the common active period. The failure cause judging unit 13 judges the cause of the failure by performing the inter-terminal communication. More specifically, when the response reply signal arrives via the wireless terminal 20a or the like as a reply to the response request signal addressed to the wireless terminal 20b, the failure cause judging unit 13 determines that the cause of the failure is a wireless link failure between the collecting terminal 10 and the wireless terminal 20b. In contrast, when no response reply signal arrives via the wireless terminal 20a or the like as a reply to the response request signal addressed to the wireless terminal 20b, the failure cause judging unit 13 determines that the cause of the failure is a defect of the wireless terminal 20b. To the wireless terminals 20a to 20c subordinate thereto, the transmitting unit 14 transmits a MAC_ACK signal in response to the data received from the wireless terminals 20a to 20c and also transmits the response request signal.

FIG. 5 is a block diagram illustrating a functional configuration of a wireless terminal 20. For example, each of the wireless terminals 20a to 20c has the functional configuration illustrated in FIG. 5. As illustrated in FIG. 5, for example, the wireless terminal 20 includes a receiving unit 21, a failure detection period setting unit 22, an intermittent operation timer 23, a failure detecting unit 24, and a transmitting unit 25. These constituent elements are connected together so as to be able to input and output signals and data in either one direction or two directions.

The receiving unit 21 receives the MAC_ACK signals and the response request signal from the collecting terminal 10. When a MAC_ACK signal contains information indicating a common active period, the failure detection period setting unit 22 sets the failure-detection active period based on the information indicating the common active period. When a failure has occurred with the wireless terminal 20 thereof or another terminal, the intermittent operation timer 23 sets a predetermined time period (e.g., 30 ms to 100 ms) as a time period during which the wireless terminal 20 operates in the active mode. When MAC_ACK signals issued in response to data transmitted to the collecting terminal 10 have consecutively failed to be received, the failure detecting unit 24 detects that a failure has occurred with the wireless terminal thereof. The transmitting unit 25 transmits data addressed to the collecting terminal 10 and also transmits the response reply signal in response to the response request signal, to the collecting terminal 10.

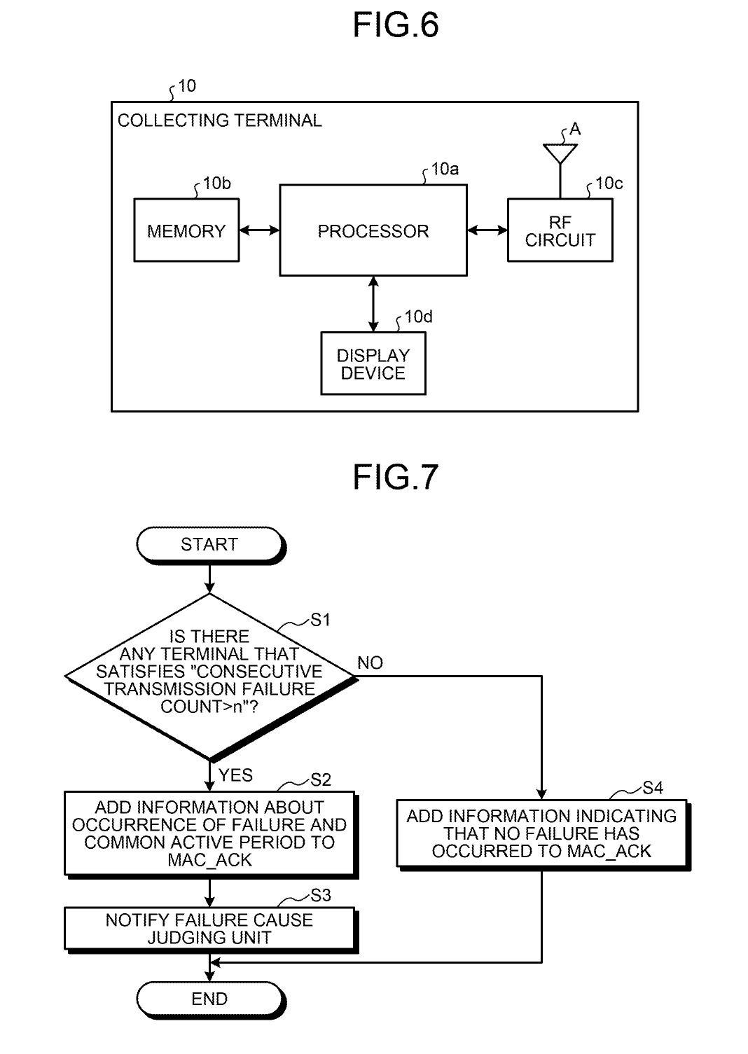

Next, a hardware configuration will be explained. FIG. 6 is a block diagram illustrating the hardware configuration of the collecting terminal 10. As illustrated in FIG. 6, the collecting terminal 10 includes, in terms of the hardware thereof, a processor 10a, a memory 10b, a Radio Frequency (RF) circuit 10c, and a display device 10d configured with a Liquid Crystal Display (LCD) or the like. The RF circuit 10c includes an antenna A. The receiving unit 11 and the transmitting unit 14 of the collecting terminal 10 are realized by the RF circuit 10c, for example, and are configured to receive the sensing data, the response reply signal, terminal neighboring information, and the like or transmit the MAC_ACK signals, the response request signal, dummy data transmission assignment information, and the like. The failure detection notifying unit 12 and the failure cause judging unit 13 are realized by the processor 10a configured with, for example, a Central Processing Unit (CPU), a Digital Signal Processor (DSP), or the like and are configured to perform processes such as detecting the occurrence of a failure, generating failure notifying information, judging the cause of a failure, and the like. The memory 10b is configured with, for example, a Random Access Memory (RAM), a Read-Only Memory (ROM), a flash memory, or the like and is configured to store therein a transmission history, a neighboring relationship, a data transmission cycle, and the like of the wireless terminal 20. The hardware configuration of the wireless terminals 20 is the same as the hardware configuration of the collecting terminal 10 described above. Thus, drawings and detailed explanations thereof will be omitted.

Next, an operation performed by the wireless communication system 1 according to the present embodiment will be explained.

FIG. 7 is a flowchart for explaining a failure detection notifying process performed by the collecting terminal 10 according to the embodiment. At step S1, the failure detection notifying unit 12 included in the collecting terminal 10 monitors a history of receiving data from the wireless terminals 20a to 20c. Further, the failure detection notifying unit 12 judges whether or not there is any wireless terminal 20 of which the count (hereinafter, “consecutive transmission failure count”) indicating how many times the wireless terminal 20 has consecutively failed in data transmission is larger than a threshold value n (where n is a natural number). The threshold value n may be set and changed as appropriate in accordance with a request from the actual system.

When there is at least one wireless terminal 20 of which the consecutive transmission failure count is larger than the threshold value n (step S1: Yes), the failure detection notifying unit 12 determines that a failure has occurred with the wireless terminal 20 (e.g., the wireless terminal 20b in the present embodiment). After that, the failure detection notifying unit 12 adds information indicating the occurrence of the failure and information indicating a common active period to the MAC_ACK signal to be sent as a reply to the wireless terminals 20a and 20c experiencing no failures (step S2). Subsequently, the failure detection notifying unit 12 notifies the failure cause judging unit 13 of the occurrence of the failure (step S3). On the contrary, when there is no wireless terminal 20 of which the consecutive transmission failure count is larger than the threshold value n (step S1: No), the failure detection notifying unit 12 determines that a failure has not occurred with any of the wireless terminals 20. After that, the failure detection notifying unit 12 adds information indicating that no failure has occurred to the MAC_ACK signal to be sent as a reply to the wireless terminals 20a and 20c (step S4). In that situation, the process at step S3 described above is omitted.

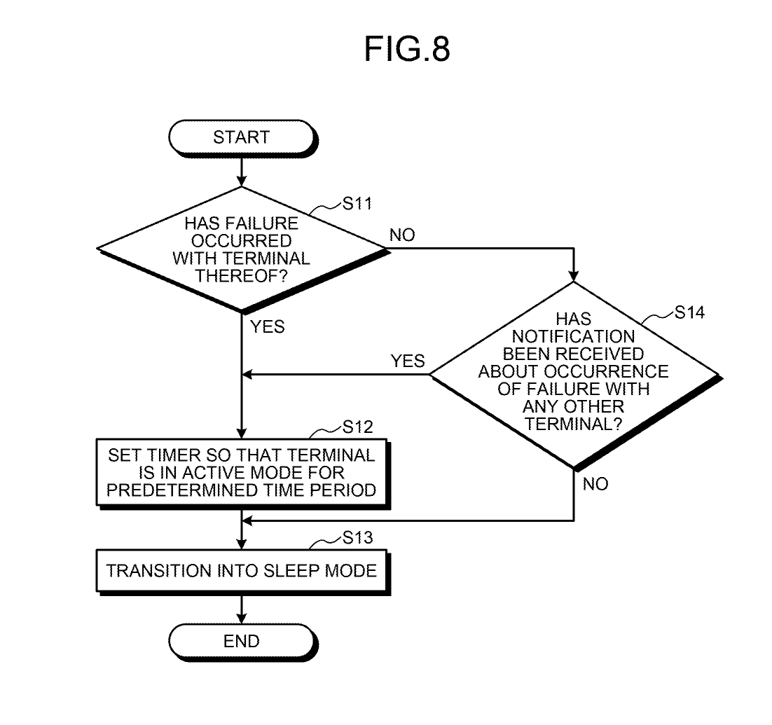

FIG. 8 is a flowchart for explaining a failure detection period setting process performed by the wireless terminal 20. For example, the wireless terminal 20 transitions from the sleep mode into the active mode at the data transmission time within each of the data transmission periods and starts the process indicated in this flowchart after transmitting the data to the collecting terminal 10.

First, the failure detecting unit 24 judges whether or not a failure has occurred with the wireless terminal 20 thereof, based on whether MAC_ACK signals issued in response to data signals transmitted therefrom have consecutively failed to be received (step S11). When a failure has occurred with the wireless terminal 20 thereof (step S11: Yes), the failure detection period setting unit 22 sets the intermittent operation timer 23 in such a manner that the wireless terminal 20 is in the active mode for a predetermined time period (step S12). The predetermined time period may be, for example, a time period lasting for 100 ms from the start of the data transmission cycle following the time of the detection of the failure. After that, when the time period set with the intermittent operation timer 23 has elapsed, the wireless terminal 20 transitions back into the sleep mode (step S13).

When no failure has occurred with the wireless terminal 20 thereof (step S11: No), the failure detecting unit 24 judges whether or not a failure has occurred with the other wireless terminals 20, based on the information contained in the received MAC_ACK signal (step S14). When a failure has occurred with at least one of the other wireless terminals 20 (step S14: Yes), the failure detection period setting unit 22 performs the process at step S12. On the contrary, when a failure has not occurred with any of the other wireless terminals 20 (step S14: No), the wireless terminal 20 performs the process at step S13.

As explained above, the wireless communication system 1 includes the collecting terminal 10 and the wireless terminals 20a and 20b that are capable of wirelessly communicating with the collecting terminal 10. The collecting terminal 10 includes the failure detection notifying unit 12 and the transmitting unit 14. The failure detection notifying unit 12 detects the non-delivery of data from the wireless terminal 20b the predetermined number of times (e.g., three times). When detecting the non-delivery of the data from the wireless terminal 20b, the failure detection notifying unit 12 determines that a failure has occurred with the wireless terminal 20b. After that, the transmitting unit 14 transmits the information indicating that the failure has occurred and the information causing the wireless terminal 20a to transition into a communicable state (e.g., the active state), to the wireless terminal 20a. The wireless terminal 20b includes the failure detection period setting unit 22. When the response signal (e.g., the MAC_ACK signal) issued in response to the data transmission to the collecting terminal 10 has failed to be received the predetermined number of times (e.g., three times), the failure detection period setting unit 22 determines that a failure has occurred with the wireless terminal 20b. Further, the failure detection period setting unit 22 included in the wireless terminal 20b causes the wireless terminal 20b to transition into a communicable state for the predetermined time period (e.g., the common active period) within the data transmission cycle. The wireless terminal 20a includes the failure detection period setting unit 22. The failure detection period setting unit 22 included in the wireless terminal 20a receives the information indicating that the failure has occurred and the information that causes the wireless terminal 20a to transition into the communicable state. After that, upon receiving these pieces of information, the failure detection period setting unit 22 included in the wireless terminal 20a causes the wireless terminal 20a to transition into the communicable state for the predetermined time period that is common between the wireless terminal 20a and the wireless terminal 20b.

In the wireless communication system 1 according to the present embodiment, each of the wireless terminals 20a to 20c transitions into the active mode only when a communication failure has occurred in the sensor network, besides when transmitting data. It is therefore possible to avoid unnecessary transitions into the active mode. With these arrangements, it is possible to prevent the wireless terminals 20a to 20c from wasting electric power, while keeping it possible to identify the cause of the failure. As a result, it is possible to realize a configuration capable of saving electric power.

Further, in the wireless communication system 1, the information indicating that a failure has occurred with another wireless terminal 20 and the information causing the wireless terminal 20 into the communicable state may be added to the response signal (e.g., the MAC_ACK signal) issued in response to the regular transmission data from the wireless terminal 20a. With this arrangement, the collecting terminal 10 is able to transmit, to the wireless terminal 20a, the information indicating that a failure has occurred with the other wireless terminal 20 and the information causing the wireless terminal 20 into the communicable state, by using the existing signal. In other words, the collecting terminal 10 does not need to provide a separate channel used for transmitting the aforementioned pieces of information, and the processing load and the electric power consumption are thus reduced.

The aforementioned pieces of information may further contain identifying information of the terminal (e.g., the wireless terminal 20b) experiencing the failure. With this arrangement, each of the normal wireless terminals (e.g., the wireless terminals 20a and 20c) is able to easily and promptly identify the wireless terminal to which the response request signal received at the time of the occurrence of the failure is to be transferred.

The one exemplary embodiment of the present disclosure has thus been explained. Next, modification examples of the embodiment described above will be explained.

### First Modification Example

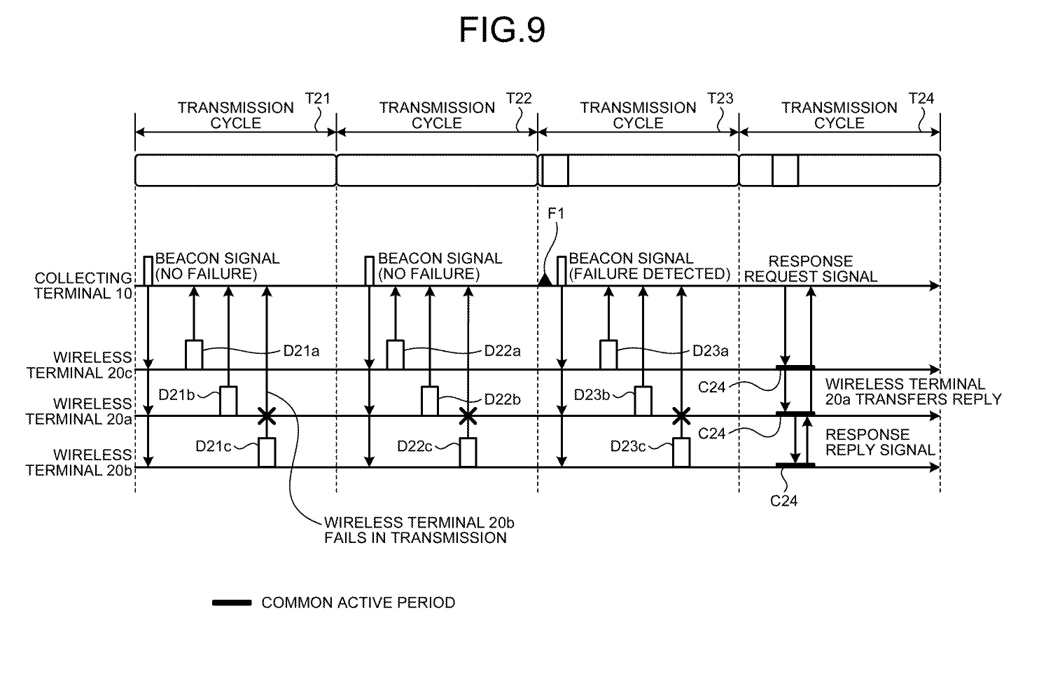

The wireless communication system 1 according to the embodiment above may be carried out in any of the modification modes described below. FIG. 9 is a drawing for explaining a failure detecting method according to a first modification example. In the embodiment described above, the collecting terminal 10 uses the MAC_ACK signal as a method for notifying the normal wireless terminals 20a and 20c of the occurrence of the failure and the designation of the common active period; however, it is also acceptable to use beacon signals, in place of the MAC_ACK signals, as illustrated in FIG. 9. The beacon signals are time synchronization signals used for correcting time differences among the wireless terminals 20a to 20c. In other words, the information indicating that a failure has occurred with another wireless terminal 20 and the information causing the wireless terminal 20 to transition into the communicable state may be added to the time synchronization signal (e.g., the beacon signal). With this arrangement, even during the time period when there is no data transmission from the wireless terminals 20a and 20b, the collecting terminal 10 is able to provide the notification about the occurrence of the failure and the designation of the common active period, with desirable timing and in a voluntary manner. As a result, it is possible to realize a configuration capable of saving electric power with a higher level of flexibility.

In this situation, during the active period used by the wireless terminals 20a to 20c for receiving the beacon signal from the collecting terminal 10 include, for example, a time period t1 and a time period t2. The time period t1 is, for example, a time period during which the beacon signal is actually transmitted and received. The time period t2 is a margin period used for preventing any reception failure that may be caused by time differences between the collecting terminal 10 and the wireless terminals 20a to 20c. The time period t1 needs to be, for example, 1.36 ms to transmit a beacon signal having a minimum size (17 bytes), at the transmission rate of 100 kbps, when the Institute of Electrical and Electronic Engineers (IEEE) 802.15.4. standard is used. Further, the margin period t2 needs to be 6 ms, because a wireless terminal using a 10 ppm timer in a 10-minute cycle can have a time difference of 6 ms at maximum, for example. For this reason, a margin of at least 6 ms is provided before and after the beacon receiving time period recorded in each of the wireless terminals 20a to 20c. Accordingly, the active period used for receiving the beacon signal from the collecting terminal 10 is arranged to be 13.36 ms or longer.

### Second Modification Example

In the embodiment described above, when having detected the failure with the wireless terminal 20b, the collecting terminal 10 also provides the wireless terminal 20c, which is not neighboring the wireless terminal 20b (i.e., is not directly communicating with the wireless terminal 20b), with the notification about the occurrence of the failure and the designation of the common active period. In contrast, in a second modification example, the collecting terminal 10 does not provide the wireless terminal 20c that is not neighboring the wireless terminal 20b detected to be experiencing the failure with the notification and the designation, but provides only the wireless terminal 20a that is neighboring the wireless terminal 20b detected to be experiencing the failure with the notification and the designation. The wireless terminal 20a neighboring the wireless terminal 20b detected to be experiencing the failure will hereinafter be referred to as a neighboring terminal. After that, during the designated common active period, the wireless terminal 20a serving as a neighboring terminal performs an inter-terminal communication with the wireless terminal 20b experiencing the failure.

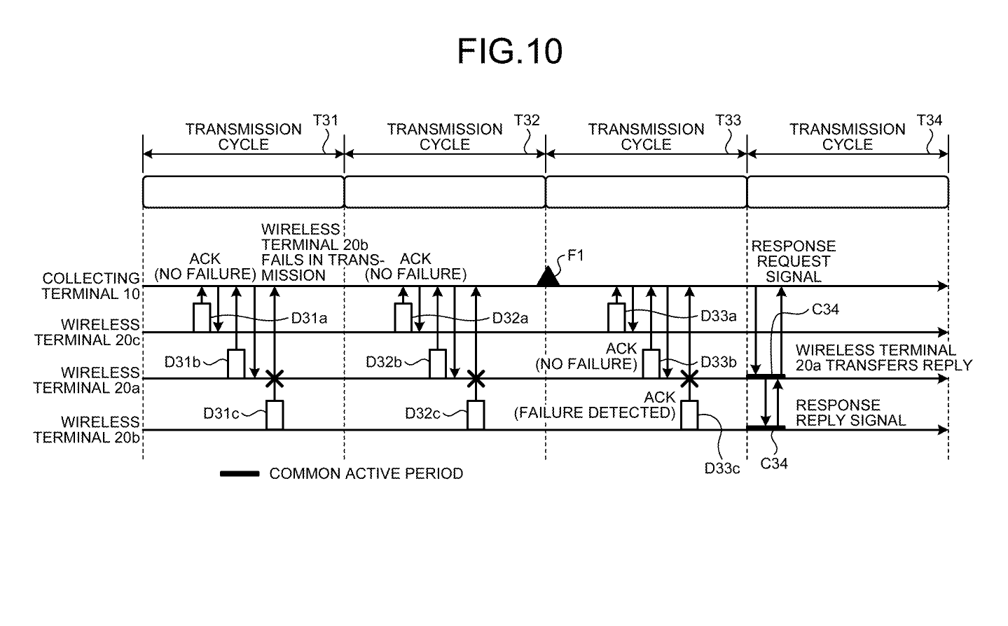

FIG. 10 is a drawing for explaining the failure detecting method according to the second modification example. In the second modification example, the collecting terminal 10 observes a neighboring relationship indicating whether or not the wireless terminals 20a to 20c are capable of communicating with one another and, from among the wireless terminals 20a to 20c subordinate thereto, the collecting terminal 10 causes only the wireless terminal 20b, which is the failed terminal, and the neighboring terminal 20a, which is capable of directly communicating with the failed terminal, to transition into the active mode. Thus, as illustrated in FIG. 10, in a transmission cycle T34, the collecting terminal 10 transmits a response request signal only to the wireless terminal 20a, and not to the wireless terminal 20c. Upon receiving the response request signal, the wireless terminal 20a transitions into the active mode. In contrast, the wireless terminal 20b detects a failure by itself because of not receiving the MAC_ACK signal and transitions into the active mode after the transmission cycle T34 is started. As a result, the common active period for the failure detection purpose is set between the wireless terminals 20a and 20b.

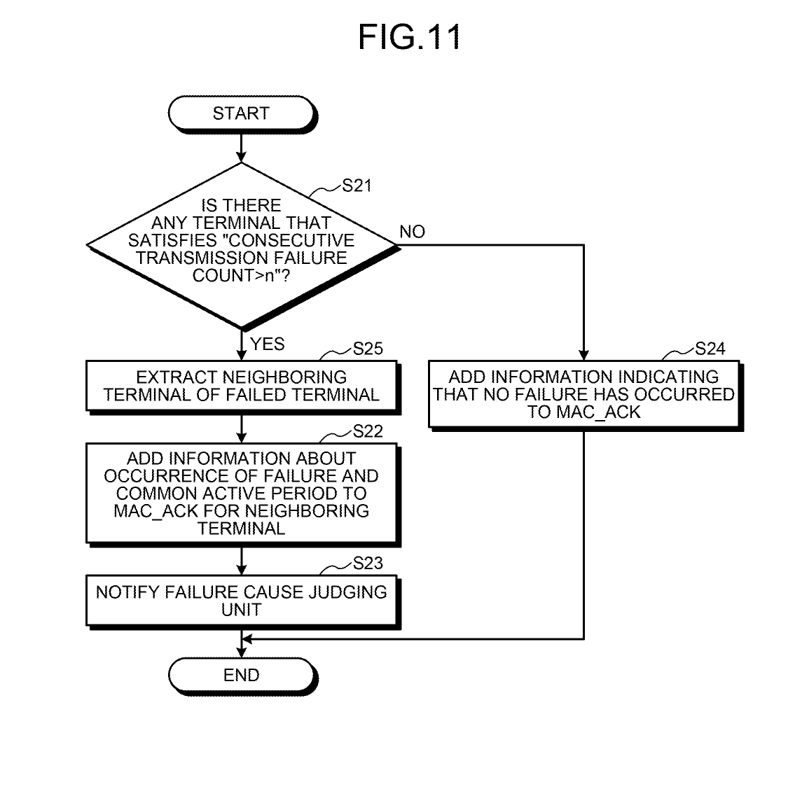

Next, an operation performed the collecting terminal 10 in the second modification example described above will be explained while focusing on differences from the embodiment described above. FIG. 11 is a flowchart for explaining a failure detection notifying process performed by the collecting terminal 10 according to the second modification example. Because some of the processes in FIG. 11 are the same as those in FIG. 7 referenced in the explanation of the operation according to the embodiment described above, the same steps will be referred to by using reference characters having the same last digits, and detailed explanations thereof will be omitted. More specifically, the processes at steps S21 to S24 in FIG. 11 correspond to the processes at steps S1 to S4 in FIG. 7, respectively.

First, when there is at least one wireless terminal 20 of which the consecutive transmission failure count for data transmissions is larger than the threshold value n (step S21: Yes), the failure detection notifying unit 12 determines that a failure has occurred with the wireless terminal 20 and extracts information about a wireless terminal 20 neighboring the failed terminal, based on the neighboring relationship described above (step S25). In the example illustrated in FIG. 1, the failure detection notifying unit 12 detects the occurrence of the failure with the wireless terminal 20b, for example, and extracts information about the wireless terminal 20a that is in a neighboring relationship with the wireless terminal 20b, based on the neighboring relationship described above. After that, the failure detection notifying unit 12 thereafter adds information indicating the occurrence of the failure and information indicating a common active period to the MAC_ACK signal to be sent as a reply to the wireless terminal 20a extracted as a neighboring terminal of the wireless terminal 20b (step S22). In this situation, the failure detection notifying unit 12 adds information indicating that no failure has occurred to the MAC_ACK signal to be sent as a reply to the wireless terminal 20c that is not neighboring the wireless terminal 20b.

As explained above, in the wireless communication system 1 according to the second modification example, the wireless terminals 20a and 20b are capable of communicating with each other because the distance therebetween is short and the electric field strength is high, as indicated in FIG. 1. However, it is difficult for the wireless terminals 20b and 20c and the wireless terminals 20a and 20c to communicate with each other because the distances therebetween are too long. For this reason, even when a failure has occurred with the wireless terminal 20b, it is difficult for the wireless terminal 20c to perform an inter-terminal communication with the wireless terminal 20b, and the transition of the wireless terminal 20c into the active mode would not contribute to the judgment on the cause of the failure. For this reason, the collecting terminal 10 identifies the neighboring terminal of the wireless terminal 20b based on the neighboring relationship among the wireless terminals 20a to 20c and causes only the neighboring terminal to transition into the active mode, by identifying the neighboring terminal as a wireless terminal 20 capable of participating in the failure detecting process. Further, when sending the MAC_ACK signals, the collecting terminal 10 adds the information indicating that a failure has occurred only to the MAC_ACK signal addressed to the wireless terminal 20a serving as the neighboring terminal and adds the information indicating that no failure has occurred to the MAC_ACK signal addressed to the wireless terminal 20c that is not serving as a neighboring terminal. In other words, the wireless terminal 20a is a wireless terminal (e.g., a neighboring terminal) that is capable of performing an inter-terminal communication with the wireless terminal 20b. With these arrangements, it is possible to avoid the situation where the wireless terminal 20c that does not contribute to the judgment on the cause of the failure transitions into the active mode in vain. It is thereby possible to enable the wireless terminal 20c to further save electric power.

The second modification example is based on the assumption that there is only one neighboring terminal (the wireless terminal 20a) for the wireless terminal 20b experiencing the failure. However, when there are two or more neighboring terminals, the collecting terminal 10 may select a wireless terminal to be notified of the occurrence of the failure, based on the remaining battery life of each of the neighboring terminals. In other words, the collecting terminal 10 may select the wireless terminal 20 having the largest remaining battery charge from among the plurality of neighboring terminals, so as to provide only the selected wireless terminal 20 with the notification about the occurrence of the failure and the designation of the common active period. With this arrangement, only the wireless terminal 20 having a sufficient remaining battery charge transitions into the active mode. Thus, it is possible to reduce the risk of having some wireless terminals 20 stop operating due to the lack of battery life. As a result, it is possible to improve reliability of the wireless communication system 1.

### Third Modification Example

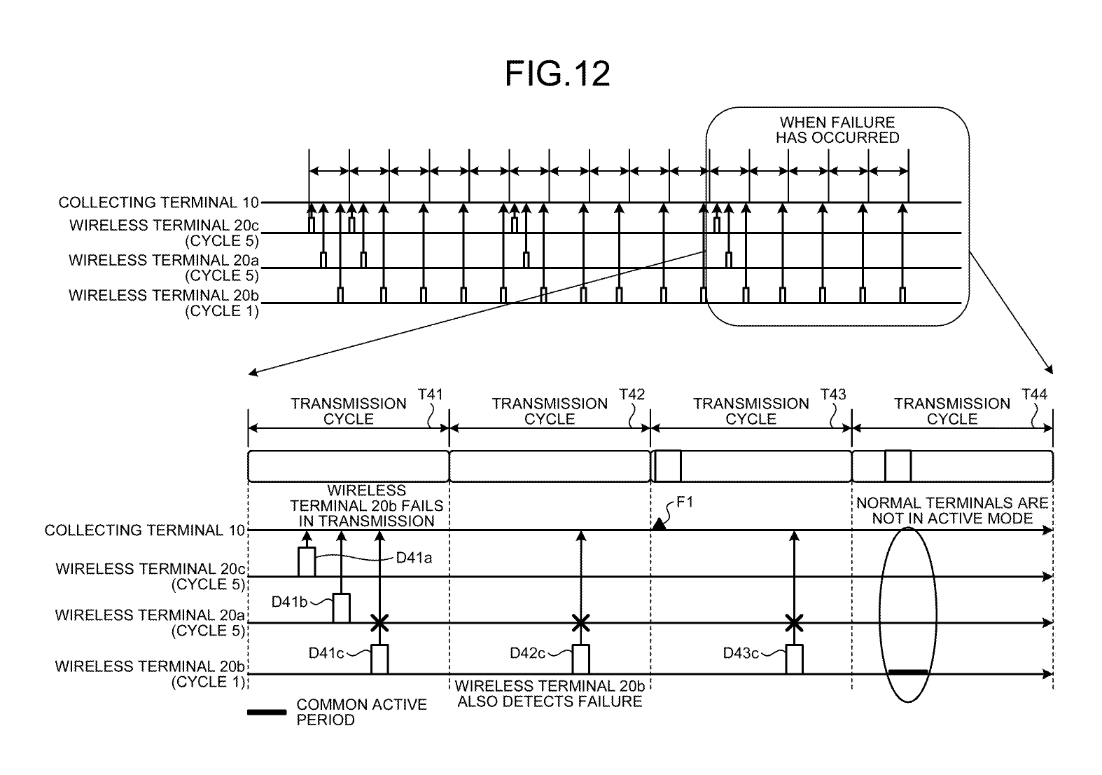

When a network is constructed in a large area, such as a sensor network in which the collecting terminal 10 collects temperature and humidity data for agriculture or meter-reading data of gas meters, there is a possibility that some of the wireless terminals (sensors) may have different transmission cycles for the data packets. FIG. 12 is a drawing for explaining a problem in a failure notification using the MAC_ACK signals when data is transmitted using different cycles. FIG. 12 illustrates an example in which the data packet transmission cycles of the wireless terminals 20a and 20c are five times as long as the transmission cycle of the wireless terminal 20b. When a failure has occurred with the wireless terminal 20b having a shorter cycle, the collecting terminal 10 detects the failure with the wireless terminal 20b in a transmission cycle T43, for example, because pieces of data sent from the wireless terminal 20b have consecutively failed to be received. Further, the wireless terminal 20b itself also detects the occurrence of the failure therewith in the transmission cycle T43, for example, because the MAC_ACK signals sent from the collecting terminal 10 have consecutively failed to be received. However, as illustrated in FIG. 12, if the normal wireless terminals 20a and 20c transmitted no data in the transmission cycle T43, the collecting terminal 10 would not be able to notify the normal wireless terminals 20a and 20c of the failure, by sending MAC_ACK signals thereto as replies. Accordingly, the wireless terminals 20a and 20c would not transition into the active mode in the following transmission cycle T44. In other words, the situation may arise where, although the wireless terminal 20b, which has detected the failure therewith, has transitioned into the active mode at the beginning of the transmission cycle T44, the other normal wireless terminals 20a and 20c have not transitioned into the active mode. As a result, a problem arises where the common active period could not be set in the transmission cycle T44.

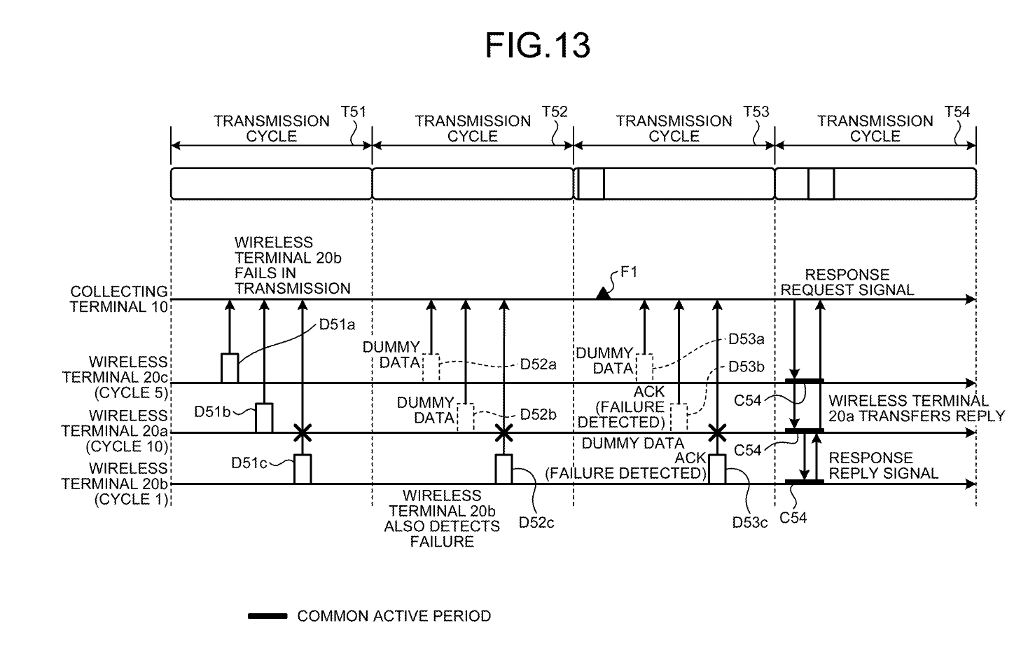

To cope with this problem, in the third modification example, all the wireless terminals 20a to 20c that are present in the same network transmit dummy data in each of the data transmission cycles, in synchronization with the cycles of the wireless terminal 20 having the shortest cycle (the wireless terminal 20b in the present modification example). FIG. 13 is a drawing for explaining a failure detecting method according to the third modification example. As illustrated in FIG. 13, in the third modification example, during transmission cycles T52 and T53, for example, the wireless terminal 20c having a longer transmission cycle transmits pieces of dummy data D52a and D53a each corresponding to a different one of the transmission cycles of the wireless terminal 20b having the shortest transmission cycle, to the collecting terminal 10. Similarly, the wireless terminal 20a having an even longer transmission cycle transmits pieces of dummy data D52b and D53b each corresponding to a different one of the transmission cycles of the wireless terminal 20b having the shortest transmission cycle, to the collecting terminal 10. The collecting terminal 10 sends replies by adding a signal indicating whether a failure has occurred or not to response signals (MAC_ACK signals) issued in response to the pieces of dummy data D52a, D52b, D53a, and D53b. With this arrangement, the collecting terminal 10 is able to provide the normal wireless terminals 20a and 20c from which the pieces of dummy data were transmitted, with the notification about the occurrence of the failure and the designation of the common active period. Because the processes performed thereafter are the same as the processes in the embodiment described above, explanations thereof will be omitted.

Each of the active periods used by the wireless terminals 20a and 20c for transmitting the dummy data include a transmission period for the dummy data itself and a reception period for the response signal (the MAC_ACK signal). For example, when the IEEE 802.15.4 standard is used, the transmission period for transmitting a piece of 15-byte dummy data having a minimum size needs to be 1.36 ms at the rate of 100 kbps. Further, because the size of the response signal (the MAC_ACK signal) is substantially the same as that of the dummy data, the reception period needs to be approximately 1.36 ms. Accordingly, it takes at least approximately 2.7 ms as the active period. The dummy data described above is, for example, data obtained by excluding a payload part from a frame (i.e., data having only a head part).

As explained above, the wireless terminal 20a includes the transmitting unit 25. When the wireless terminal 20a has a different data transmission cycle from those of the other wireless terminals 20b and 20c that are capable of wirelessly communicating with the collecting terminal 10, the transmitting unit 25 transmits the dummy data to the collecting terminal 10 by using the data transmission cycles of the wireless terminal 20b having the shortest data transmission cycle between the wireless terminals 20b and 20c. The collecting terminal 10 includes the transmitting unit 14. When the non-delivery of the data from the wireless terminal 20b is detected, the transmitting unit 14 transmits, to the wireless terminal 20a, the information causing the wireless terminal 20a to transition into the communicable state (e.g., the active state), by adding the information to the response signal (e.g., the MAC_ACK signal) issued in response to the dummy data described above.

The failure detecting method according to the third modification example is applicable to the wireless communication system 1 in which the data transmission cycles are mutually different among the wireless terminals 20a to 20c. In other words, even when the transmission cycles of the wireless terminals 20a to 20c in the network are not the same as one another, the collecting terminal 10 is able to identify the cause of the failure that occurred with any of the wireless terminals 20a to 20c.

In the third modification example, the wireless terminals 20a and 20c of which the transmission cycles are not the shortest are arranged to transmit the dummy data in each of all the cycles other than the cycles used for transmitting the sensing data (the regular transmission data). Accordingly, the active period becomes longer, and an increase in the electric power consumption may be concerned. However, because the transmission period of the dummy data is usually shorter than the common active period, the time periods during which the normal wireless terminals 20a and 20c operate in the active mode do not have to be long, and the electric power consumption is therefore lower than in related examples.

### Fourth Modification Example

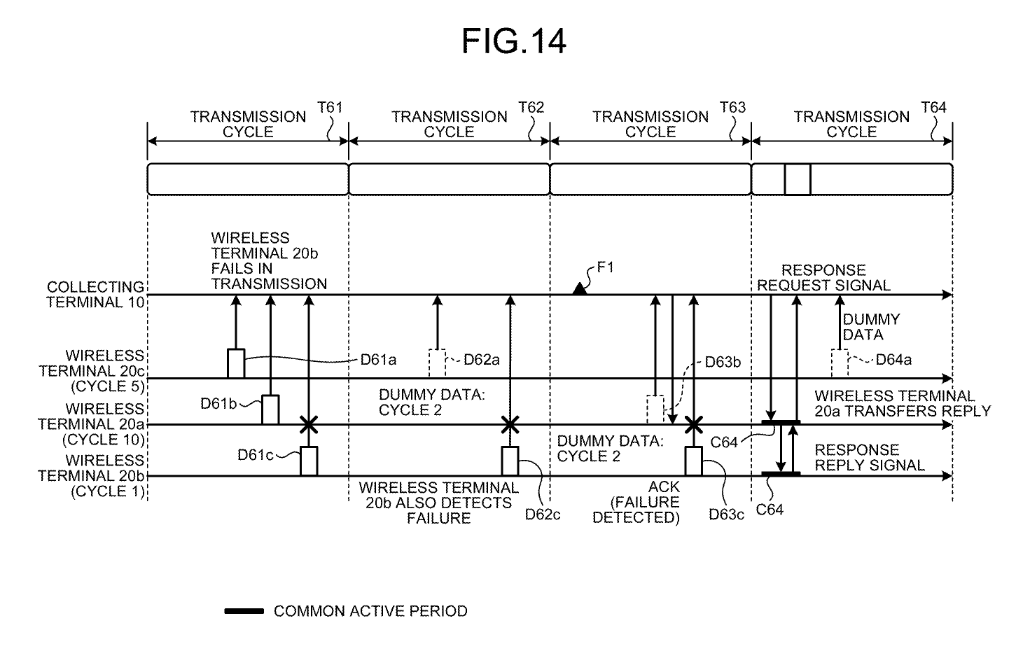

In the third modification example, the collecting terminal 10 is configured in such a manner that the timing with which the dummy data is transmitted from the two normal wireless terminals (20a and 20c) is assigned to each of all the transmission cycles of the wireless terminals 20b experiencing the failure. However, the present disclosure is not limited to this example. For instance, the timing with which the dummy data is transmitted with respect to all of the transmission cycles of the wireless terminal 20b may be assigned in such a manner that at least one transmission is performed in each of the transmission cycles of the wireless terminal 20b. FIG. 14 is a drawing for explaining a failure detecting method according to a fourth modification example. As illustrated in FIG. 14, in the fourth modification example, the collecting terminal 10 observes the neighboring relationship among the wireless terminals 20a to 20c that are subordinate thereto. Further, the collecting terminal 10 designates transmission cycles and transmission timing of the dummy data for the wireless terminals 20a to 20c, in accordance with the transmission cycle (cycle 1) of the wireless terminal 20b having the shortest transmission cycle and the quantity of the neighboring terminals thereof.

For example, when the transmission cycle of the wireless terminal 20b having the shortest transmission cycle is ten minutes, while the quantity of the wireless terminals neighboring the wireless terminal 20b is “2”, the collecting terminal 10 designates a cycle for the two neighboring terminals so that a piece of dummy data is transmitted once every twenty minutes. In the example illustrated in FIG. 14, the two neighboring terminals are the wireless terminals 20a and 20c. In other words, the collecting terminal 10 divides each of the twenty-minute periods into a first period from 0 to 10 minutes and a second period from 10 to 20 minutes. After that, the collecting terminal 10 assigns the first period to the wireless terminal 20c and the second period to the wireless terminal 20a. As a result, the collecting terminal 10 is able to assign the transmissions of the dummy data in such a manner that at least one neighboring terminal transmits data (e.g., dummy data or sensing data) in any of the transmission cycles of the wireless terminal 20b having the shortest transmission cycle. In the example illustrated in FIG. 14, the transmission cycle of the wireless terminal 20b is “1”, whereas the quantity of the wireless terminals (20a and 20c) neighboring the wireless terminal 20b is “2”. Accordingly, the collecting terminal 10 instructs the wireless terminals 20a and 20c to transmit dummy data by using a transmission cycle of “2(=1×2)”. Because the processes performed thereafter are the same as the processes in the third modification example above, explanations thereof will be omitted.

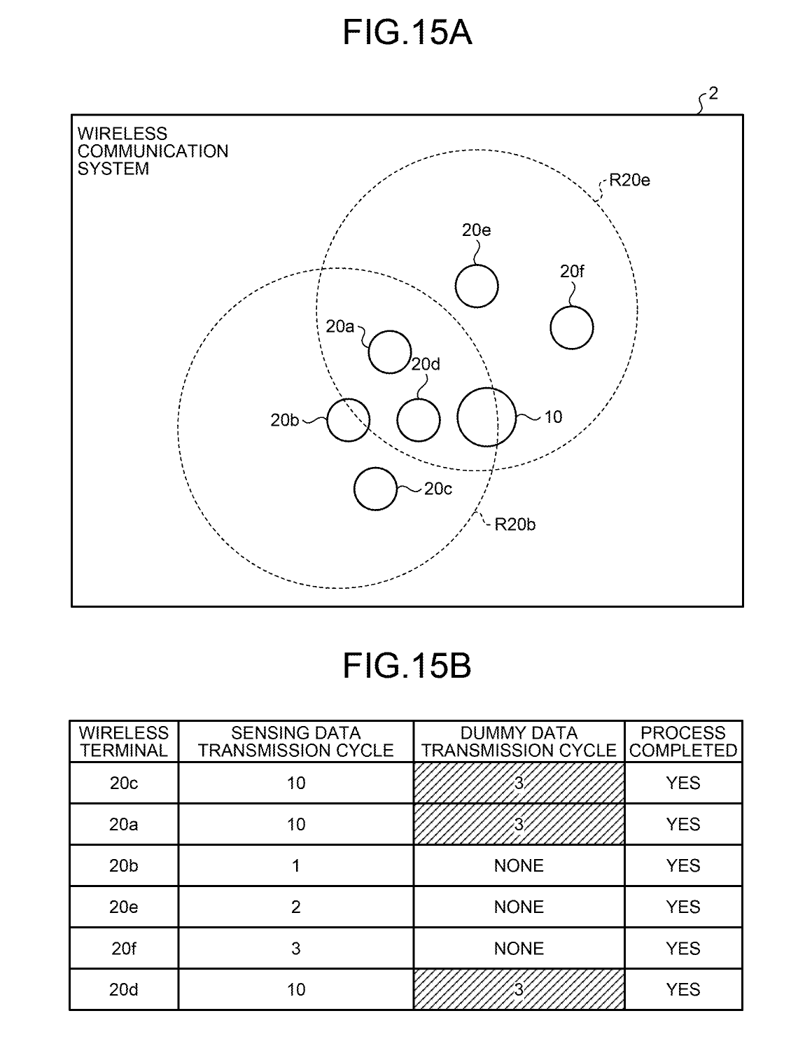

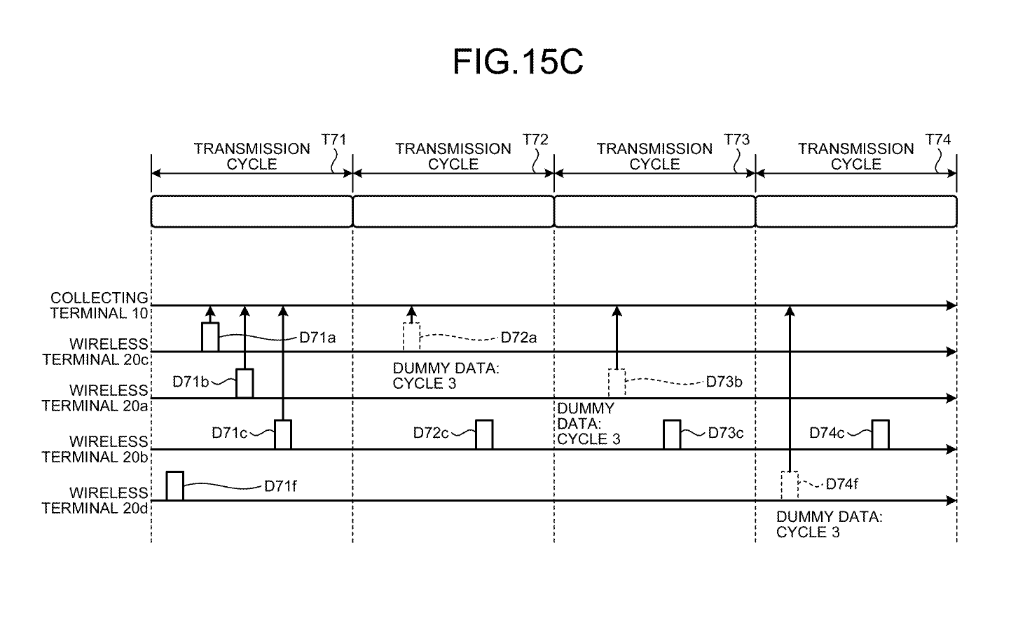

FIG. 15A is a diagram illustrating a wireless communication system 2 in which six wireless terminals 20a to 20f are present as being subordinate to the collecting terminal 10 according to the fourth modification example. In the following sections, the failure detecting method according to the fourth modification example will be explained more specifically by using the example of the wireless communication system 2 illustrated in FIG. 15A.

First, the collecting terminal 10 sorts the wireless terminals 20a to 20f in ascending order of the lengths of the sensing data transmission cycles. FIG. 15B is a table illustrating transmission cycles of sensing data and dummy data for each of the wireless terminals according to the fourth modification example. As illustrated in FIG. 15B, because the transmission cycles for the sensing data arranged in the ascending order correspond to the wireless terminals 20b, 20e, 20f, 20c, 20a, and 20d, the wireless terminals 20a to 20f are sorted into the stated order. In this situation, when two or more of the wireless terminals 20 have mutually the same transmission cycle for the sensing data, those wireless terminals 20 are sorted in ascending order of the quantity of neighboring wireless terminals 20. In the example illustrated in FIG. 15B, because the transmission cycles for the sensing data of the wireless terminals 20c, 20a, and 20d are all “10”, these wireless terminals are sorted, as indicated in FIG. 15A, in ascending order of the quantity of neighboring terminals, i.e., the wireless terminals 20c, 20a, and 20d.

After that, the collecting terminal 10 checks to see whether at least one data transmission from a neighboring terminal is performed during each of all the sensing data transmission cycles of the wireless terminal 20b, which is in the first place in the sorted result. FIG. 15C is a chart for explaining the method for assigning dummy data transmission cycles according to the fourth modification example. Among all of the sensing data transmission cycles of the wireless terminal 20b, when there is at least one cycle during which data is not transmitted from any of the neighboring terminals, the collecting terminal 10 assigns transmission cycles and transmission timing of the dummy data to the wireless terminals 20c, 20a, and 20d neighboring the wireless terminal 20b. The transmission cycle of the dummy data is, for example, cycle 3 indicated with hatching in FIG. 15B. The transmission timing for the dummy data is, for example, 3 minutes after the cycle is started. On the contrary, when all of the sensing data transmission cycles of the wireless terminal 20b have at least one data transmission from a neighboring terminal, the collecting terminal 10 performs the same process on the wireless terminal 20e which is in the next place in the sorted result. When the updating process is completed on the data transmission cycles of all of the wireless terminals 20a to 20f, the collecting terminal 10 ends the series of processes.

For example, as indicated in FIG. 15B, because the wireless terminals 20a and 20d transmit dummy data, it means that the dummy data transmissions from the neighboring wireless terminals 20a and 20d are already present in the transmission cycles of the wireless terminals 20e. For this reason, although the wireless terminal 20f is neighboring the wireless terminal 20e, the wireless terminal 20f does not need to transmit any dummy data. Accordingly, the dummy data transmission cycle of the wireless terminal 20f is set as “NONE”.

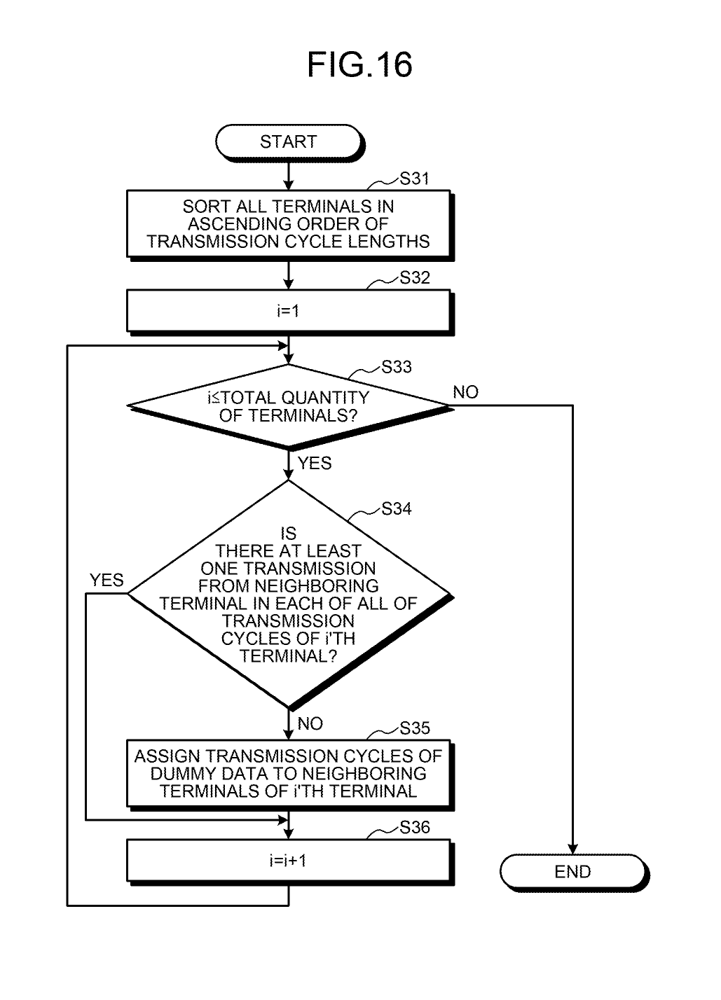

FIG. 16 is a flowchart for explaining the dummy data transmission cycle assigning process performed by the collecting terminal 10 according to the fourth modification example.

First, the failure cause judging unit 13 included in the collecting terminal 10 sorts all the wireless terminals 20 that are subordinate thereto in ascending order of the lengths of the sensing data transmission cycles (step S31). Subsequently, the failure cause judging unit 13 sets 1 as an initial value of a variable i indicating the quantity of terminals (step S32). The failure cause judging unit 13 judges whether the value of the variable i at the current point in time is equal to or smaller than the total quantity of terminals (“6” in the fourth modification example).

When the value of the variable i is equal to or smaller than the total quantity of terminals (step S33: Yes), the failure cause judging unit 13 judges whether or not there is at least one data transmission from a neighboring terminal of the wireless terminal 20 in the i′th place in the sorted result, in each of all the data transmission cycles of the i′th wireless terminal 20 (step S34). Among all of the data transmission cycles of the i′th wireless terminal 20, when there is at least one cycle during which data is not transmitted from any of the neighboring terminals (step S34: No), the failure cause judging unit 13 assigns dummy data transmission cycles to such cycles of the neighboring terminals of the i′th wireless terminal 20 that correspond to the data transmission cycles (step S35). After that, the failure cause judging unit 13 increments the quantity of terminals i by 1 (step S36) and performs the process at step S33 again.

On the contrary, when there is at least one data transmission from a neighboring terminal in each of all the data transmission cycles of the i′th wireless terminal 20, (step S34: Yes), the process at step S35 described above is omitted. When the value of the variable i is larger than the total quantity of terminals (step S33: No), the collecting terminal 10 ends the series of dummy data transmission cycle assigning processes.

As explained above, the collecting terminal 10 includes the failure cause judging unit 13. The failure cause judging unit 13 determines the dummy data transmission cycles of the wireless terminals 20 in accordance with the data transmission cycles and the quantity of the wireless terminals 20, in such a manner that, with respect to the data transmission cycles of the wireless terminal 20b having the shortest data transmission cycle among the plurality of wireless terminals 20a to 20f, the pieces of dummy data described above are transmitted from the wireless terminals 20c, 20a, and 20d that are capable of performing the inter-terminal communication with the wireless terminal 20b. Each of the wireless terminals 20c, 20a, and 20d includes the transmitting unit 25 that transmits the dummy data to the collecting terminal 10 by using the dummy data transmission cycles determined by the failure cause judging unit 13.

With these arrangements, at least one neighboring terminal transmits data in any of the cycles of the wireless terminal 20b having the shortest transmission cycle. Thus, even when a failure has occurred with the wireless terminal 20b having the shortest transmission cycle, the collecting terminal 10 is able to promptly notify the neighboring terminals of the occurrence of the failure. Further, the collecting terminal 10 is also able to notify, in an exhaustive manner, the neighboring terminals of each of the wireless terminals 20 of a failure occurring with any of the wireless terminals 20 included in the wireless communication system 2. Further, unlike the third modification example, with respect to the data transmission cycles of the wireless terminal 20 having the shortest cycle, it is sufficient if at least one wireless terminal 20 is in an active state for each of the transmission cycles. For this reason, the frequency with which the dummy data is transmitted from the wireless terminals 20 is lower. As a result, the number of times the normal wireless terminals 20 are caused to transition into the active mode is reduced, and it is therefore possible to realize a configuration capable of further saving electric power. Further, the wireless terminals 20 that consume electric power by transitioning into the active mode are evenly distributed, without being concentrated on a single terminal. It is therefore possible to avoid the situation where only a specific wireless terminal 20 consumes electric power at an early stage and stops operating.

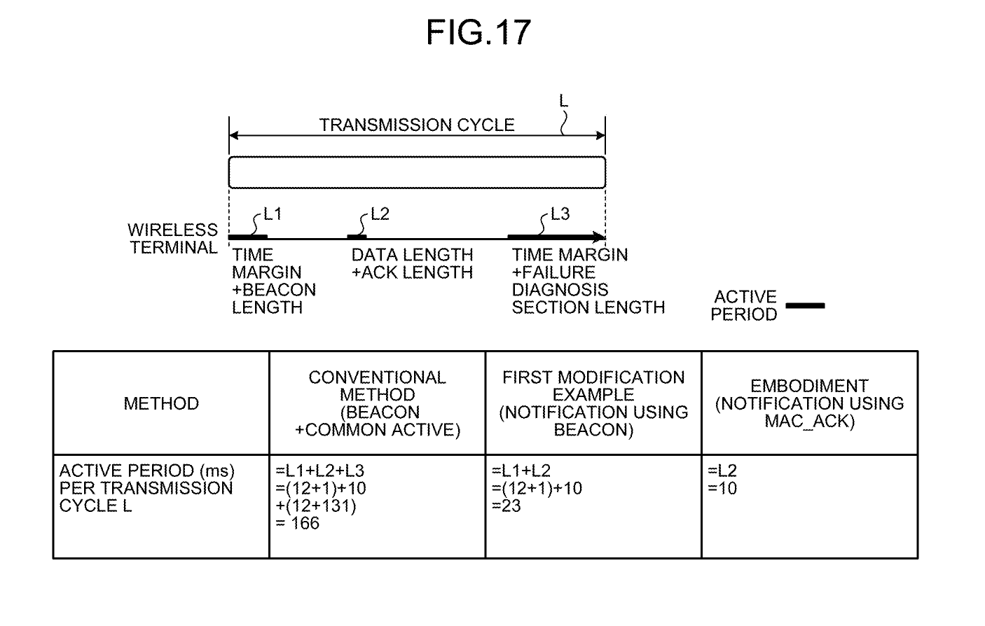

As explained above, the wireless terminals 20 transition into the active mode that is in common, only when a failure has occurred with one of the terminals. Consequently, it is possible to significantly reduce the electric power used for judging the cause of the failure. FIG. 17 is a drawing for explaining advantageous effects of the wireless communication systems 1 and 2. As illustrated in FIG. 17, in a related method, the active period (ms) per transmission cycle L is L1 (time margin+beacon length)+L2 (data length+ACK length)+L3 (time margin+failure diagnosis section length). In contrast, the active period is reduced to L1+L2 according to the first modification example and is reduced to L2 according to the embodiment described above. For example, when the time margin corresponding to a transmission cycle of ten minutes and a timer precision level of 10 ppm is assumed to be “12 ms”, while the failure diagnosis section length needed when the quantity of wireless terminals in the network is 100 is assumed to be “131 ms”, the active period in the related example is “166 ms”. In contrast, in the first modification example, the active period is reduced to “23 ms”. Further, the active period is reduced to as short as “10 ms” according to the embodiment. Further, when the effect is calculated in terms of the life of a coin battery, the life of the battery is approximately one year in the related example, whereas the life of the battery is extended up to approximately five to ten years according to the embodiment described above and the modification examples.

In the exemplary embodiments and the modification examples, the wireless communication network is assumed to be a sensor network. However, the wireless communication systems 1 and 2 are applicable to any other network such as an ad-hoc network or a mesh network, as long as wireless terminals perform an intermittent operation in the network. Further, besides temperature and humidity data for an agricultural land or meter-reading data of gas meters, the data collected by the collecting terminal 10 from the wireless terminals 20 may be data measuring a soil moisture content or measured data used for biological researches.

Further, the wireless terminals do not necessarily have to be sensor nodes; it is possible to apply the failure cause judging techniques of the wireless communication systems 1 and 2 to various types of communication devices that perform wireless communications, such as tablet terminals, smartphones, portable phones, Personal Digital Assistants (PDAs), or the like. To judge the cause of a failure, the collecting terminal 10 judges whether the cause of the failure lies in a defect of the wireless terminal itself or a failure in a wireless link. However, when a wireless terminal is not able to transmit the response reply signal to the collecting terminal 10 via any of the neighboring terminals thereof, there is a possibility that, other than the wireless terminal having a defect, the wireless terminal may be in the state of being unable to wirelessly communicate with any other wireless terminal due to the presence of a blocking object or the like, even if the wireless terminal itself has no defect. Accordingly, when the collecting terminal 10 does not receive the response reply signal from a wireless terminal, a system administrator or the like may check to see, in a complementary manner, whether the wireless terminal actually has a defect or not, by visually checking the wireless terminal in the installed location thereof or the like. With this arrangement, it is possible to identify the cause of the failure more accurately.

In the exemplary embodiments and the modification examples described above, the constituent elements of the wireless communication systems 1 and 2 do not necessarily have to physically be configured as indicated in the drawings. In other words, the specific modes of distribution and integration of the apparatuses are not limited to those illustrated in the drawings. It is acceptable to functionally or physically distribute or integrate all or a part of the apparatuses in any arbitrary units, depending on various loads and the status of use. For example, the failure detection period setting unit 22 and the intermittent operation timer 23 illustrated in FIG. 5 may be integrated together as one constituent element. On the contrary, the failure cause judging unit 13 illustrated in FIG. 4 may be distributed into, for example, a section that judges the cause of a failure by performing the inter-terminal communication and a section that determines the dummy data transmission cycles of the neighboring terminals in accordance with the shortest data transmission cycle and the quantity of the neighboring terminals. Further, the memory 10b may be connected via a network or a cable, as an external device of the collecting terminal 10.

Further, in the description above, the individual configurations and operations are explained for each of the individual exemplary embodiments and modification examples. However, each of the wireless communication systems 1 and 2 according to the exemplary embodiments and the modification examples may also include any of the constituent elements that are specific to any other embodiment or modification example. It is acceptable to combine any of the exemplary embodiments and the modification examples together, in any arbitrary mode, such as combining not only two examples but also three or more examples. For example, the failure notifying function using the beacon signals according to the first modification example is applicable not only to the embodiment, but also to the second modification example. Further, as long as the wireless communication systems 1 and 2 are each able to function without conflicting with each other, the wireless communication systems 1 and 2 each may also include all the constituent elements explained in the exemplary embodiments and the first to the fourth modification examples described above.

According to at least one aspect of the wireless communication system, the wireless communication apparatus, and the wireless communication method of the present disclosure, it is possible to reduce the electric power consumption.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wireless communication system including a wireless communication apparatus and first and second terminals capable of wirelessly communicating with the wireless communication apparatus, wherein
the wireless communication apparatus includes:
a processor configured to execute a process including:
detecting non-delivery of data from the first terminal; and
first transmitting, when the non-delivery of the data is detected, information causing the second terminal to transition into a communicable state to the second terminal, and
the first terminal includes:
a first processor configured to execute a first process including causing, when a response signal issued in response to a data transmission fails to be received, the first terminal to transition into a communicable state for a predetermined time period that is within a cycle of the data transmission, and
the second terminal includes:
a second processor configured to execute a second process including causing, upon receiving the information, the second terminal to transition into the communicable state for the predetermined time period that is common between the first terminal and the second terminal.

2. The wireless communication system according to claim 1, wherein the information causing the transition into the communicable state is added to a response signal issued in response to data transmitted from the second terminal.

3. The wireless communication system according to claim 1, wherein the information causing the transition into the communicable state is added to a synchronization signal transmitted from the wireless communication apparatus to the second terminal.

4. The wireless communication system according to claim 1, wherein the second terminal is a wireless terminal capable of performing an inter-terminal communication with the first terminal.

5. The wireless communication system according to claim 1, including: a plurality of wireless terminals including the first and the second terminals, wherein
each of the wireless terminals includes:
a processor configured to execute a process including second transmitting dummy data to the wireless communication apparatus in data transmission cycles of such a wireless terminal that has a shortest data transmission cycle among the plurality of wireless terminals, and
when the non-delivery of the data is detected, the first transmitting includes transmitting the information causing the transition into the communicable state to the wireless terminals by adding the information to a response signal issued in response to the dummy data.

6. The wireless communication system according to claim 1, including: a plurality of wireless terminals including the first and the second terminals, wherein
the process executed by the wireless communication apparatus further includes determining, to ensure that dummy data is transmitted in data transmission cycles of such a wireless terminal that has a shortest data transmission cycle among the plurality of wireless terminals, from another one of the wireless terminals capable of wirelessly communicating with such a wireless terminal, transmission cycles for the dummy data from the another wireless terminal, in accordance with the data transmission cycles and a quantity of the wireless terminals, and
the another wireless terminal includes:
a processor configured to execute a process including second transmitting, when having received an instruction about the transmission cycles for the dummy data determined at the determining, the dummy data to the wireless communication apparatus in the instructed transmission cycles.

7. A wireless communication apparatus capable of wirelessly communicating with a first terminal and a second terminal, the wireless communication apparatus comprising:
a processor configured to execute a process including:
detecting non-delivery of data from the first terminal; and
causing, when the non-delivery of the data is detected, the second terminal to transition into a communicable state for a predetermined time period that is within a cycle of data transmissions to the wireless communication apparatus and is common between the first terminal and the second terminal, by transmitting information causing the second terminal to transition into the communicable state to the second terminal.

8. A wireless communication method implemented by a wireless communication system including a wireless communication apparatus and first and second terminals capable of wirelessly communicating with the wireless communication apparatus, the wireless communication method comprising:
detecting non-delivery of data from the first terminal, by the wireless communication apparatus;
transmitting, when the non-delivery of the data is detected, information causing the second terminal to transition into a communicable state to the second terminal, by the wireless communication apparatus;
causing, when a response signal issued in response to a data transmission fails to be received, the first terminal to transition into a communicable state for a predetermined time period that is within a cycle of the data transmission, by the first terminal; and
causing, upon receiving the information, the second terminal to transition into the communicable state for the predetermined time period that is common between the first terminal and the second terminal, by the second terminal.
